(19) United States
(12) Patent Application Publication
(10) Pub. No.: US 2015/0252613 A1
(43) Pub. Date: Sep. 10, 2015

(54) Fully Open Panel Arrangement with Multiple Guide Rails for Large Window/Door Opening

(71) Applicant: Alan Shihgar Lui, Monterey Park, CA (US)

(72) Inventor: Alan Shihgar Lui, Monterey Park, CA (US)

(21) Appl. No.: 14/197,157

(22) Filed: Mar. 4, 2014

(51) Int. Cl. E06B 3/92; E06B 3/46; E06B 1/04

(52) U.S. Cl. CPC E06B 3/922; E06B 1/04; E06B 3/46; E06B 3/4609; E06B 3/4636; E06B 3/469

(57) ABSTRACT

A fully open panel arrangement, arranged for opening and closing an opening of a wall, includes one or more window/door panels, and a mounting frame mounting the window/door panels in position, wherein the mounting frame is mounted to the wall outside of the opening, not within the opening, wherein in a fully open state, each of the window/door panels moves to a position beside the opening for fully exposing the opening. The configuration of the fully open window/door arrangement increases at least 50% open space in comparison with the conventional window arrangements. If the wall of a window/door opening does not provide any space adjacent to the window/door opening, the panels of the fully open window/door arrangement cannot be moved to a position beside the opening for fully exposing the opening. In this case, the fully open window/door arrangement using multiple guide rails with more than two multiple panels can still increase the open space via narrower window/door panels in comparison with the conventional window/door arrangement.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a panel arrangement, and more particularly to a panel arrangement, which can be embodied as a window arrangement or a door arrangement, installed at an outer side or an inner side of a wall adjacent to an opening of the wall for increasing the open space when the panel arrangement is in an open state.

2. Description of Related Arts

A conventional window arrangement is often constructed in a wall or roof that functions to admit light or air into an enclosure and is generally fitted with one or more glass panels that permits opening and closing. A conventional door arrangement, which may comprise one or more slidable or rotatable door panels, is also mounted in a wall for opening and closing a door opening. However, both of these window or door arrangements are constructed to be built-in structures in the wall, and thus the open space when the window or door arrangements are in a fully open state is limited and it is also inconvenient to adjust the effective open space.

As a specific example, referring to FIG. 1 of the drawings, a conventional window arrangement according to a prior art is illustrated, the conventional window arrangement comprises an outer frame 100 and two glass panels 200 which are mounted within an opening 300 of a wall. The outer frame 100 defines two sliding paths for the two glass panels 200 respectively. Accordingly, when the conventional window arrangement is in an open state, one of the glass panels 200 slides along the sliding path to a position overlappedly aligning with the other glass panels 200 for creating an open space for letting in air and light.

However, this conventional window arrangement has a drawback. When the two glass panels overlap with each other to provide the open space, only half space of the opening is exposed to the outer side. In other words, when in use, the opening 300 of the wall is divided into two parts and one of the two parts is used for creating the open space while the other part is used for accommodating the glass panels. Therefore, the room for shelter of the glass panels cannot be used for letting in air into the house.

It is thus can be seen that the space within the opening of the wall is quite limited for creating the open space, for a large portion of the space within the opening of the wall is required to install and ensure the movement of the glass panels 200 of the convention window arrangement. In addition, the depth of the opening 300 of the wall is also limited and when the glass panels 200 are installed in position, there may be no space for installing screen windows for keeping out flies and dust.

Furthermore, when installing the window arraignment, the outer frame 100 should be mounted within the opening 300 of the wall, so that the outer frame 100 should be precisely shaped and sized to match with the opening 300 of the wall. In addition, it is pretty difficult to carry out the mounting operation along the inner surface around the opening 300 of the wall.

When one of the glass panels 200 breaks down or has to be replaced, it is also difficult to detach the glass panel 200 from the opening 300 of the wall. According to the conventional structure of the window arrangement, the whole arrangement has to be detached from the opening 300 of the wall or the glass panel 200 to be replaced may have to be damaged before removing. It is thus a great waste of time and material.

### SUMMARY OF THE PRESENT INVENTION

The main object of the present invention is to provide a fully open panel arrangement which is installed at an outer side or an inner side of a wall for increasing an open space when the panel arrangement is in an open state.

Another object of the present invention is to provide a fully open panel arrangement, wherein the panel arrangement can be embodied as a window arrangement or a door arrangement, wherein when in the open state, the window opening or door opening can be fully exposed for increasing the open space.

Another object of the present invention is to provide a fully open panel arrangement, wherein when in a fully open state, the fully open window or door arrangement is capable of increasing at least 50% open space in comparison with the conventional window arrangement.

Another object of the present invention is to provide a fully open panel arrangement, wherein the mounting frame of the panel arrangement is not mounted within the opening of the wall, but instead, is mounted on the wall adjacent to the opening, so that the mounting area defined by the mounting frame is larger than the opening of the wall and can be mounted with multiple panels and multiple guide rails.

Another object of the present invention is to provide a fully open panel arrangement, wherein in the fully open state, the window/door panels of the window/door arrangement actually slide to a position adjacent to the opening of the wall, so that the opening of the wall can be totally exposed.

Another object of the present invention is to provide a fully open panel arrangement, wherein the window/door arrangement is installed at the outer side or inner side of the wall instead of within the opening of the wall, so that the installing process can be simplified and easy to carry out.

Another object of the present invention is to provide a fully open panel arrangement, wherein the space of the opening of the wall can be spared and used for other purposes.

Another object of the present invention is to provide a fully open panel arrangement, wherein the widow/door panels are easy to be detached from the mounting frame of the window/door arrangement and replaced with new ones.

Another object of the present invention is to provide a fully open panel arrangement, wherein the window/door panels are easy to move between the fully open state, the partially open state, and the fully closed state via the guide rails of the window/door arrangement.

Another object of the present invention is to provide a fully open panel arrangement, wherein no complicated structure is required and the mounting process of the window/door arrangement is easy.

Additional advantages and features of the invention will become apparent from the description which follows, and may be realized by means of the instrumentalities and combinations particular point out in the appended claims.

According to the present invention, the foregoing and other objects and advantages are attained by a fully open panel arrangement for opening and closing an opening of a wall comprising one or more opening panels, and a mounting frame mounting the opening panels in position. The mounting frame is mounted to the wall at an outer side of the opening. When in a fully open state, each of the opening panels moves to a position beside the opening for fully exposing the opening.

In accordance with another aspect of the invention, the present invention provides a method of providing a fully open panel arrangement for opening and closing an opening of a wall. The method comprises the following steps.

(a) Overlap one or more opening panels with the opening of the wall to close the opening of the wall.

(b) Move each of the opening panels to a position beside the opening of the wall to fully expose the opening of the wall.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a conventional window arrangement.

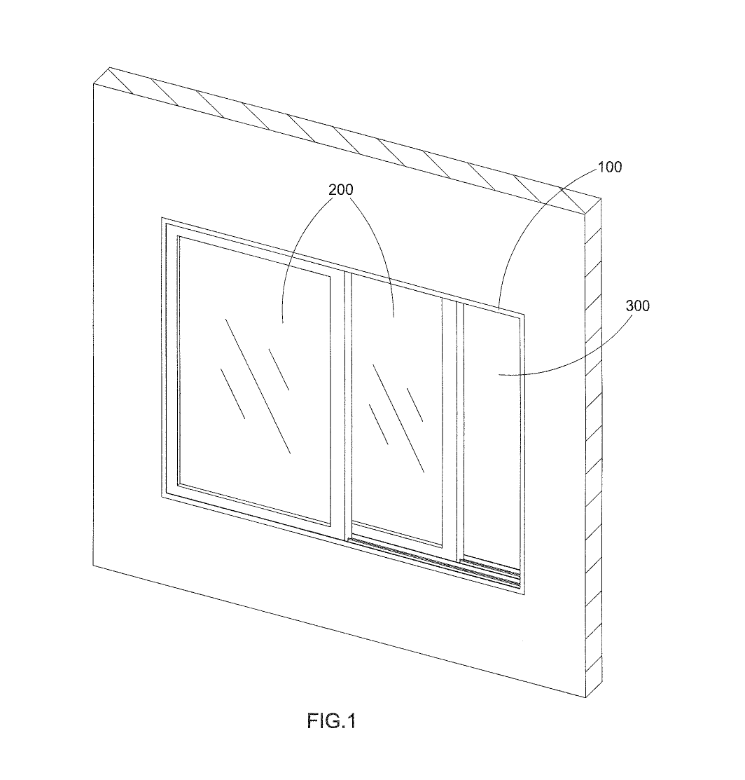

FIG. 2A is a perspective view illustrating a fully open panel arrangement in an open state according to a first preferred embodiment of the present invention.

FIG. 2B is a perspective view illustrating a fully open panel arrangement in a closed state according to the above first preferred embodiment of the present invention.

FIG. 2C is a sectional view of the fully open panel arrangement according to the above first preferred embodiment of the present invention.

FIG. 3A is a perspective view illustrating a fully open panel arrangement in an open state according to a second preferred embodiment of the present invention.

FIG. 3B is a perspective view illustrating a fully open panel arrangement in a closed state according to the above second preferred embodiment of the present invention.

FIG. 3C is a sectional view of the fully open panel arrangement according to the above second preferred embodiment of the present invention.

FIG. 4A is a perspective view illustrating a fully open panel arrangement in an open state according to a third preferred embodiment of the present invention.

FIG. 4B is a perspective view illustrating a fully open panel arrangement in a closed state according to the above third preferred embodiment of the present invention.

FIG. 4C is a sectional view of the fully open panel arrangement according to the above third preferred embodiment of the present invention.

FIG. 5 is a perspective view of a fully open panel arrangement according to an alternative mode of the above third preferred embodiment of the present invention.

FIG. 6A is a perspective view illustrating a fully open panel arrangement in an open state according to a fourth preferred embodiment of the present invention.

FIG. 6B is a perspective view illustrating a fully open panel arrangement in a partial open state according to the above fourth preferred embodiment of the present invention.

FIG. 6C is a sectional view of the fully open panel arrangement according to the above fourth preferred embodiment of the present invention.

FIG. 7A is a perspective view illustrating a fully open panel arrangement in an open state according to a fifth preferred embodiment of the present invention.

FIG. 7B is a perspective view illustrating the fully open panel arrangement in a closed state according to the above fifth preferred embodiment of the present invention.

FIG. 8A is a perspective view illustrating a fully open panel arrangement in an open state according to a sixth preferred embodiment of the present invention.

FIG. 8B is a perspective view illustrating the fully open panel arrangement in a closed state according to the above sixth preferred embodiment of the present invention.

FIG. 9A is a perspective view illustrating a fully open panel arrangement in an open state according to a seventh preferred embodiment of the present invention.

FIG. 9B is a perspective view illustrating the fully open panel arrangement in a closed state according to the above seventh preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

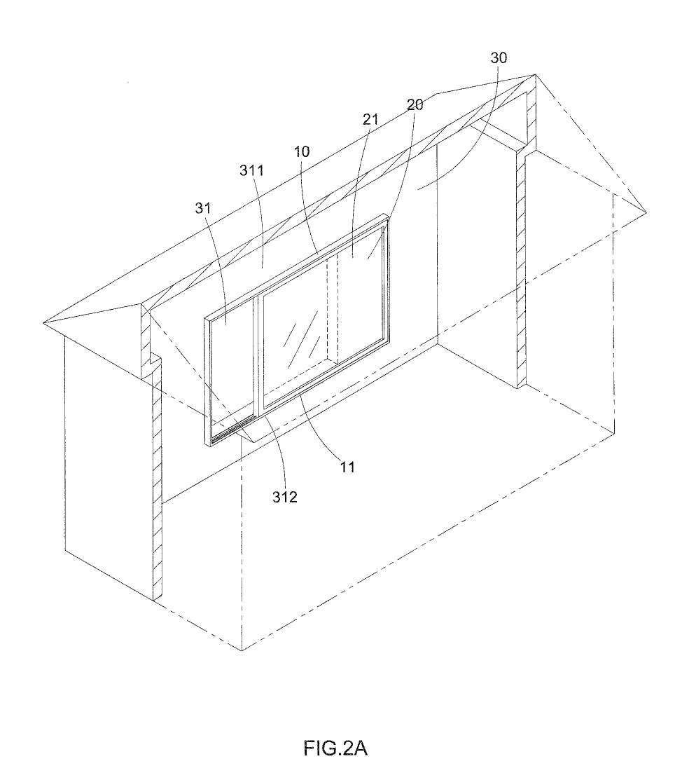

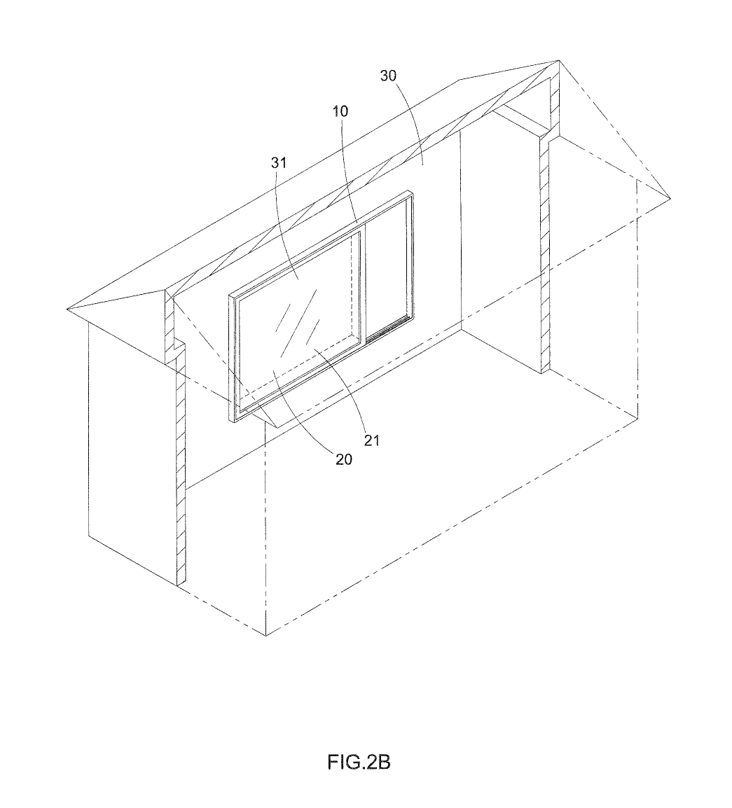

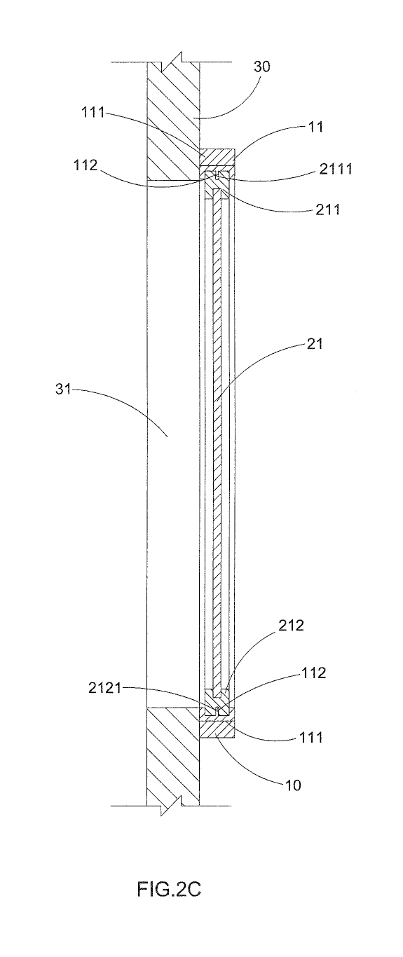

Referring to FIGS. 2A to 2C of the drawings, a fully open panel arrangement according to a first preferred embodiment of the present invention is illustrated. The fully open window arrangement, which is embodied as a fully open window arrangement, comprises a mounting frame 10, and one or more opening panels which are embodied as window panels 20. The fully open window arrangement is coupled with an opening 31 of a wall 30 for letting in air and light. The fully open window arrangement can be installed at an outer side or an inner side of the wall. The wall can be a side wall of a building, a roof of a house, a wall of a vehicle and the like. The opening 31 penetrates the outer surface and the inner surface of the wall 30. Accordingly, when the wall 30 is a wall of an enclosure, the opening 31 functions to communicate the inner space of the enclosure to outside.

According to this preferred embodiment of the present invention, the fully open window arrangement is mounted at the inner side of the wall 30. More specifically, the fully open window arrangement, which comprises one window panel 20, is mounted adjacent to the opening 31 of the wall 30 instead of within the opening 31 of the wall 30. Similarly, the fully open window arrangement is mounted at an outer side of the opening 31 of the wall and is adapted for exposing or concealing the opening 31 of the wall 30.

The mounting frame 10 comprises at least one guide rail 11, the window panel is slidalbly coupled with the guide rail 11 in such a manner that the window panel is adapted for moving between an open state in which the window panel 20 slides to a position beside the opening 31 for exposing the opening 31 and a closed state in which the window panel 20 slides to a position overlappedly aligning with the opening 31 for concealing the opening 31.

In other words, the space at the outer side of the opening 31 and the inner side of the wall 30 is utilized to accommodate the fully open window arrangement of the present invention. Since there is a large vacant space available for the shelter of the fully open window arrangement at the outer side of the opening 31 of the wall 30, the installation of the fully open window arrangement is easy and convenient.

More specifically, according to this preferred embodiment of the present invention, two guide rails 11 of the mounting frame 10 can be respectively coupled with the upper inner surface 311 and lower inner surface 312 of the wall 30 around the opening 31 for guiding the window panel 20. Correspondingly, the window panel 20 comprises a panel body 21 having an upper end portion 211 and a lower end portion 212 slidably coupling with the guide rails 11 of the mounting frame 20 respectively. Therefore, the window panel 20 can be extended between the two guide rails 11. A distance of the two guide rails 11 can be a little larger than a height of the opening 31. Alternatively, only a single guide rail 11 is provided for guiding the sliding movement of the window panel 20.

According to this preferred embodiment of the present invention, the window panel 20 moves in a horizontal direction to open or close the opening 31 of the wall. Particularly, when in the fully open state, the window panel 21 may be retained at a left or right side of the opening 31 of the wall 30, so that the opening 31 can be completely exposed to communicate the inner side of the wall 30 to outside. In other words, when in the fully open state, the shelter of the window panel 21 does not have influence on the exposing of the opening 31 of the wall 30, so that the total opening 31 of the wall 30 is available for letting in air.

The slidable movement of the window panel 20 with respect to the guide rails 11 can be achieved by many manners. For example, referring to FIG. 2C of the drawings, each of the upper and lower end portions 211 and 212 of the panel body 21 defines a sliding groove 2111 and 2121. Each of the guide rails 11 comprises a retention seat 111 and a sliding member 112 protruded from the retention seat 112. The sliding members 112 are respectively engaged with the sliding grooves 2111 and 2121 in such a manner that the panel body 21 slides along the retention seat 111 between the two guide rails 11.

Accordingly, unlike the conventional window arrangement in which the window panels can only slide within the opening, the window panels 20 of the fully open window arrangement is provided with enough space for facilitating the sliding movement. In other words, a relatively long sliding path can be provided for the window panel 20 in comparison with the conventional window arrangement.

In addition, one or more handles can be mounted on the panel body 21 for a user to grip on to guide the sliding movement. A remote actuation mechanism may also be provided for remotely controlling the movement of the window panel 20. Furthermore, one or more detachable retention arrangements also can be provided for ensuring the positioning of the window panel 20 in the open and closed states. More specifically, for example, the detachable retention arrangement may comprise a first retention member provided at the window panel 20 and a second retention member at the to inner surface of the wall 30 or at the mounting frame 10. When in the closed state, the first retention member is coupled with the second retention member to retain the window panel 20 in position. The first retention member and the second retention member may engage with each other in a tongue-groove manner, a clipping manner, a magnetic attracting manner, or other detachable coupling manners.

The panel body 21 of the window panel 20 can be made of transparent material, such as glass, so that when in the closed state, the panel body 21 still serves to let light pass through.

Furthermore, since the window panel 20 is able to move to a position beside the opening 31 of the wall 30, the window panel 20 is easy to detach from the mounting frame 10, and thus the replacing of the window panel 20 is also easy and the window panel 20 is not likely to damage during the replacing process. However, in the conventional window arrangement, the window panels are all installed in the opening 31 of the wall 30, so that it is not convenient to replace the window panels.

It is worth mentioning that the mounting frame 10 can be mounted to the wall 30 via a variety of manners. For example, the mounting frame 10 may be installed to the wall 30 via screws, rivets, and the like. Alternatively, the mounting frame 10 is bonded to the wall 30 via glues. Other mounting methods also can be employed.

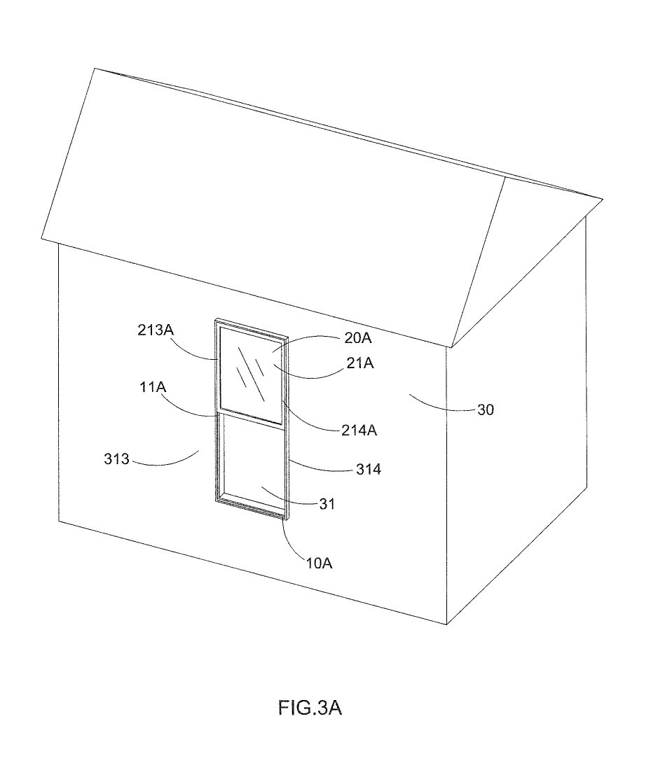

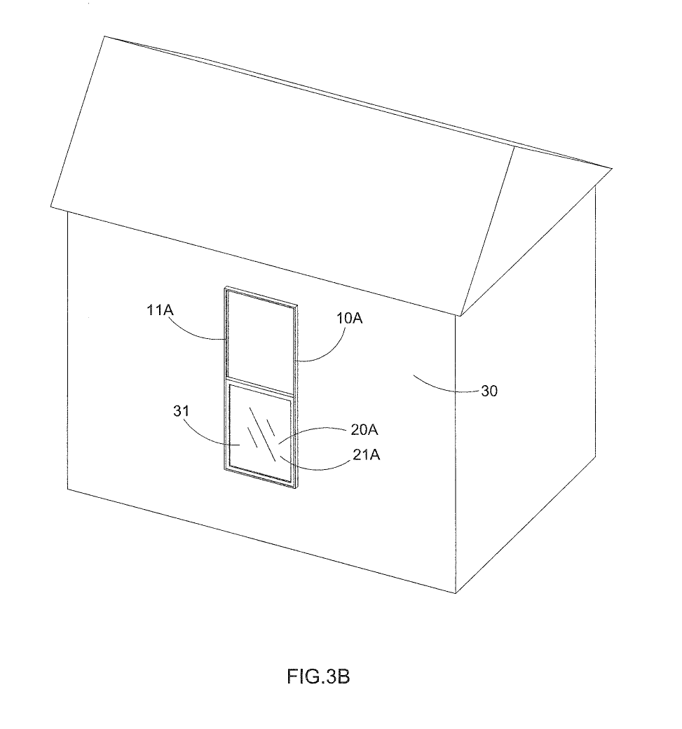

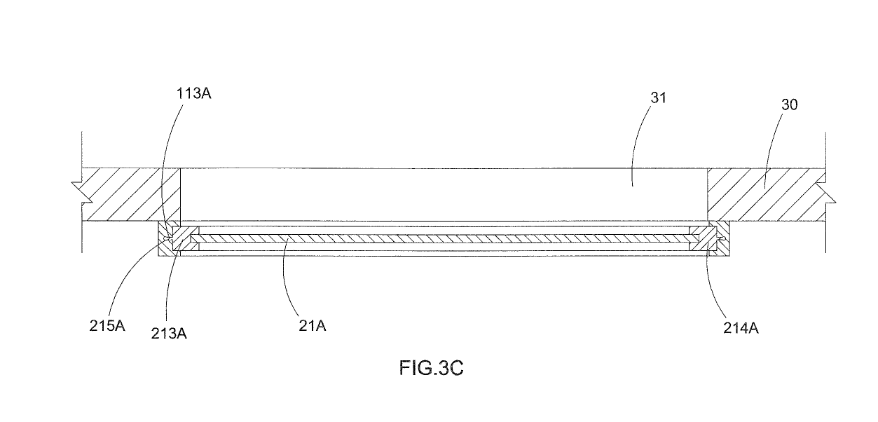

Referring to FIGS. 3A to 3C of the drawings, a fully open window arrangement according to a second preferred embodiment of the present invention is illustrated. The fully open window arrangement comprises a mounting frame 10A, and a window panel 20A. The fully open window arrangement is coupled with an opening 31 of a wall 30 for letting in air and light.

According to this second preferred embodiment of the present invention, the fully open window arrangement is mounted at the outer side of the wall 30. More specifically, the fully open window arrangement, which comprises one window panel 20A, is mounted adjacent to the opening 31 of the wall 30 at the outer side of the enclosure of the wall 30.

The mounting frame 10A comprises at least one guide rail 11A, the window panel is slidalbly coupled with the guide rail 11A in such a manner that the window panel is adapted for moving between an open state in which the window panel 20A slides to a position beside the opening 31 for exposing the opening 31 and a closed state in which the window panel 20A slides to a position overlappedly aligning with the opening 31 for concealing the opening 31.

More specifically, according to this second preferred embodiment of the present invention, two guide rails 11A of the mounting frame 10A can be respectively coupled with the left outer surface 313 and right outer surface 314 of the wall 30 around the opening 31 for guiding the window panel 20A. Correspondingly, the window panel 20A comprises a panel body 21A having a left end portion 213A and a right end portion 214A slidably coupling with the guide rails 11A of the mounting frame 20A respectively. Therefore, the window panel 20A can be extended between the two guide rails 11A. A distance of the two guide rails 11A can be a little larger than a width of the opening 31.

According to this second preferred embodiment of the present invention, the window panel 20A moves in a vertical direction to open or close the opening 31 of the wall 30. Particularly, when in the fully open state, the window panel 21A may be retained at an upper or lower side of the opening 31 of the wall 30, so that the opening 31 can be completely exposed to communicate the inner side of the wall 30 to outside. In other words, when in the fully open state, the shelter of the window panel 21A does not have influence on the exposing of the opening 31 of the wall 30, so that the total opening 31 of the wall 30 is available for letting in air.

The slidable movement of the window panel 20A with respect to the guide rails 11A can be achieved by many manners. For example, referring to FIG. 3C of the drawings, each of the left and right end portions 213A and 214A of the panel body 21A has a sliding member 215A. Each of the guide rails 11A defines a sliding groove 113A. The sliding members 215A are respectively engaged with the sliding grooves 113A in such a manner that the panel body 21A slides between the two guide rails 11A.

Accordingly, according to this second preferred embodiment of the present invention, the mounting frame 10A provides a vertical sliding path for the window panel 20A. Alternatively, the lateral end portions 213A and 214A, which are lateral edges of the window panel 20A, can be embodied as the sliding members that slide along the sliding grooves 113A respectively.

It is worth mentioning that other moving manners also can be employed for moving the window panel 20A between different positions. For example, the window panel 20A may comprise telescoping rods extended from the panel body 21A. The telescoping rods shift between a retracting position and an extending positing, so that the panel body 21A corresponding moves between the open state and the closed state.

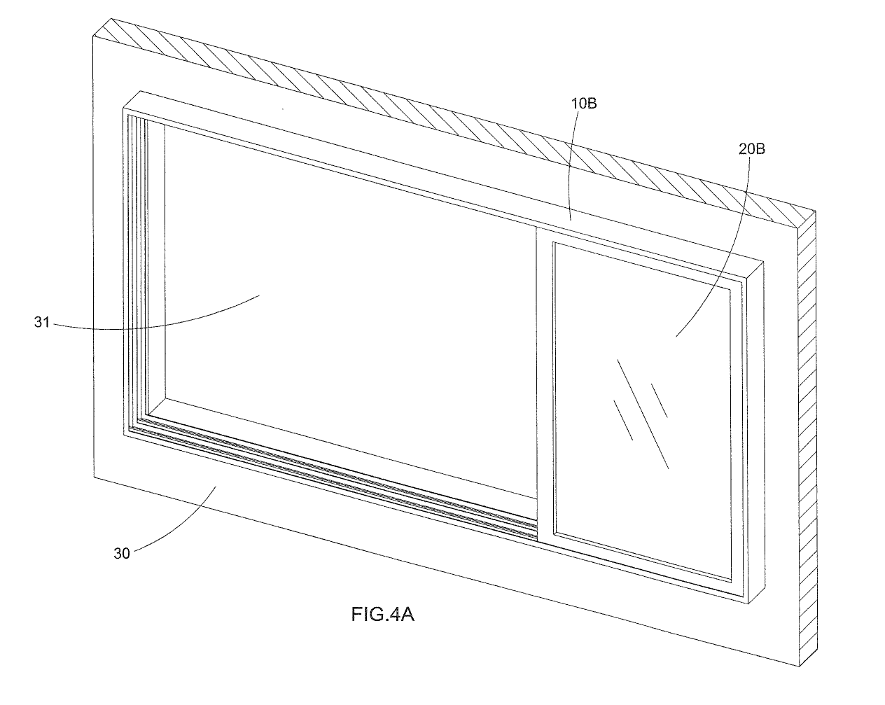

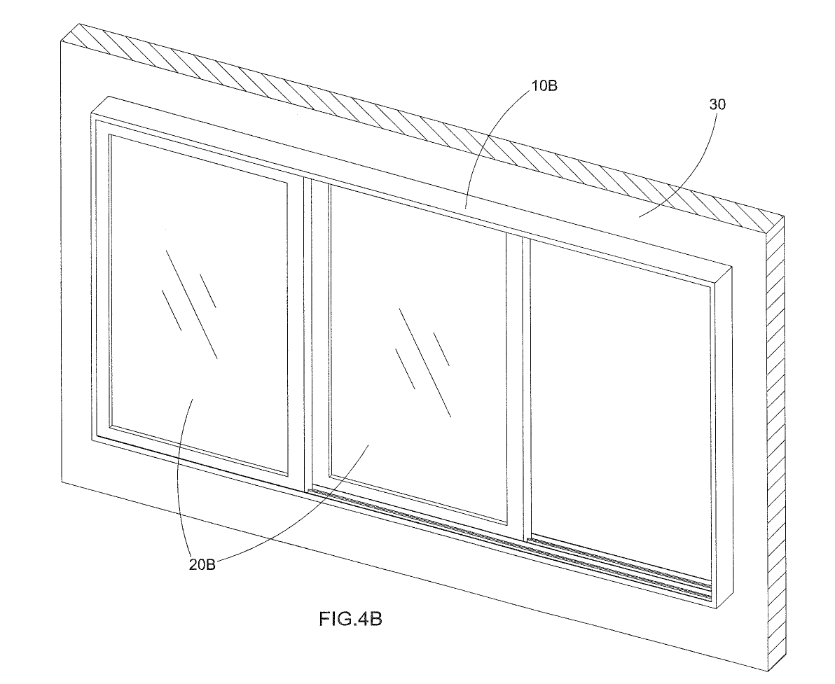

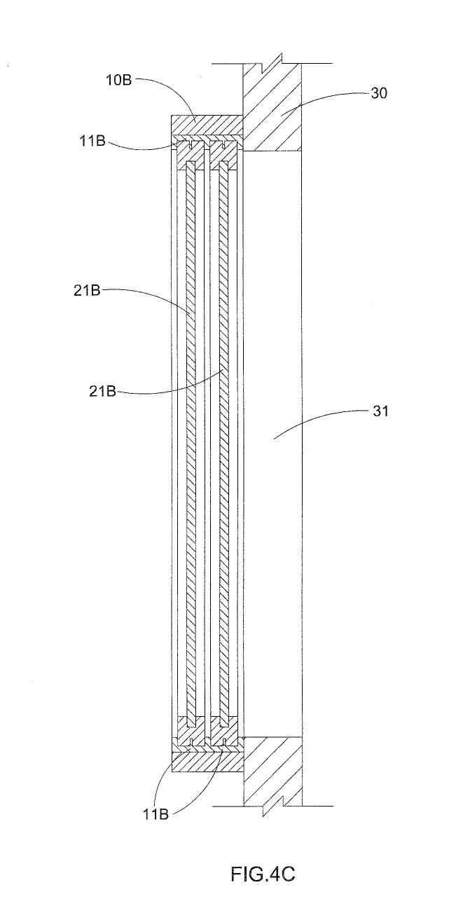

Referring to FIGS. 4A to 4C of the drawings, a fully open window arrangement according to a third preferred embodiment of the present invention is illustrated. The fully open window arrangement comprises a mounting frame 10B, and two window panels 20B. The fully open window arrangement is coupled with an opening 31 of a wall 30 for letting in air and light.

According to this third preferred embodiment of the present invention, the fully open window arrangement is capable of moving between a fully open state, a partial open state, and a closed state. In the fully open state, the two window panels 20B move to a position beside the opening 31 of the wall 30 for fully exposing the opening 31. In the partial open state, one or two of the two window panels 20B overlap with the opening 31 for exposing a partial part of the opening 31 of the wall 30. In the closed state, the two window panels 20B close the whole opening 31 of the wall 30.

More specifically, the mounting frame 10B comprises two groups of guide rails 11B for coupling with the two window panels 20B respectively. For example, the two groups of the guide rails 11B are parallelly and spacedly arranged for guiding the sliding movement of the two window panels 20B. Accordingly, a user can selectively guide one or both two of the window panels 20B to slide along the corresponding group of guide rails 11B to overlappedly align with the opening 31 of the wall 30, so that the fully open window arrangement can be guided to stay in the partial open state. For example, one window panel 20B is guided to a position overlapping with the opening 31 of the wall 30, so that a half portion of the opening 31 of the wall 30 can be exposed. Alternatively, the two window panels 20B may stagger with each other for partially exposing the opening 31 of the wall 30.

It is worth mentioning that proper retention structure, when required, also can be provided for retaining the window panels 20 in the above mentioned states.

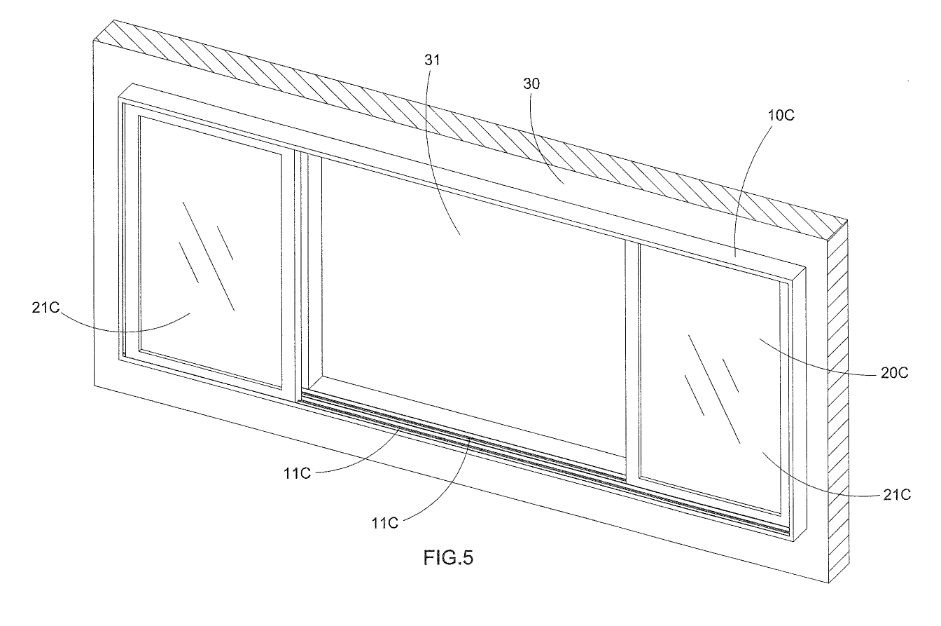

Referring to FIG. 5 of the drawings, a fully open window arrangement according to an alternative mode of the above third preferred embodiment of the present invention is illustrated. According to this preferred embodiment, the two window panels 20C can slide in two opposed directions for allowing the fully open window arrangement moving between the fully open state, the partial open state, and the closed state. Accordingly, when in the fully open state, the two window panels 20C are retained at two sides of the opening 31 of the wall 30. In other words, the opening 31 of the wall 30 is exposed in middle of the two window panels 20C when in the fully open state. Corresponding, when in the closed state, the two window panels 20C move towards each other to close the opening 31 of the wall 30.

Accordingly, the two window panels 20B of the above third preferred embodiment are arranged in parallel planes, the two window panels 20C of this preferred embodiment can be arranged in a same plane. In addition, the two window panels 20C can be coupled with one guide rail 11C. In other words, the two window panels 20C may slide with respect to different portions of the same guide rail 11C in opposite directions so as to shift between different states.

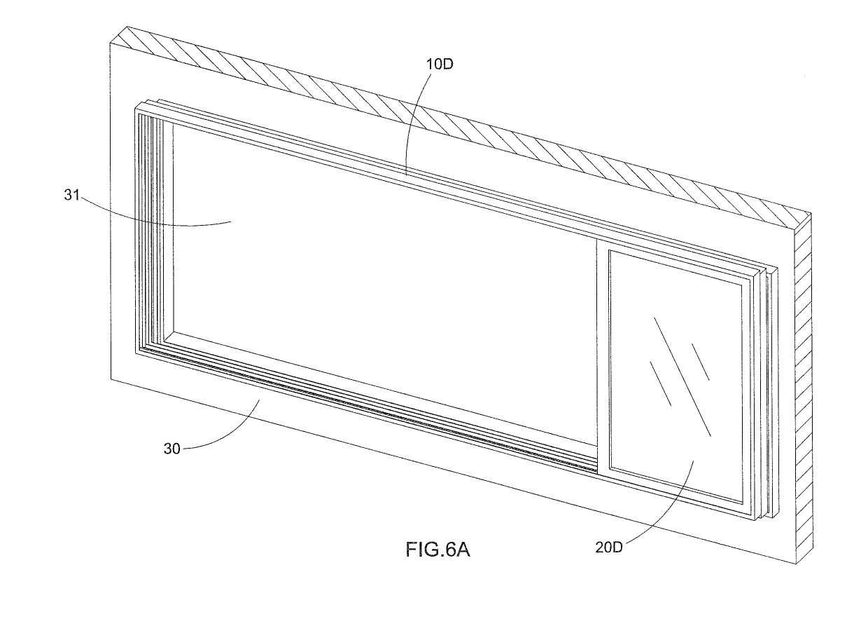

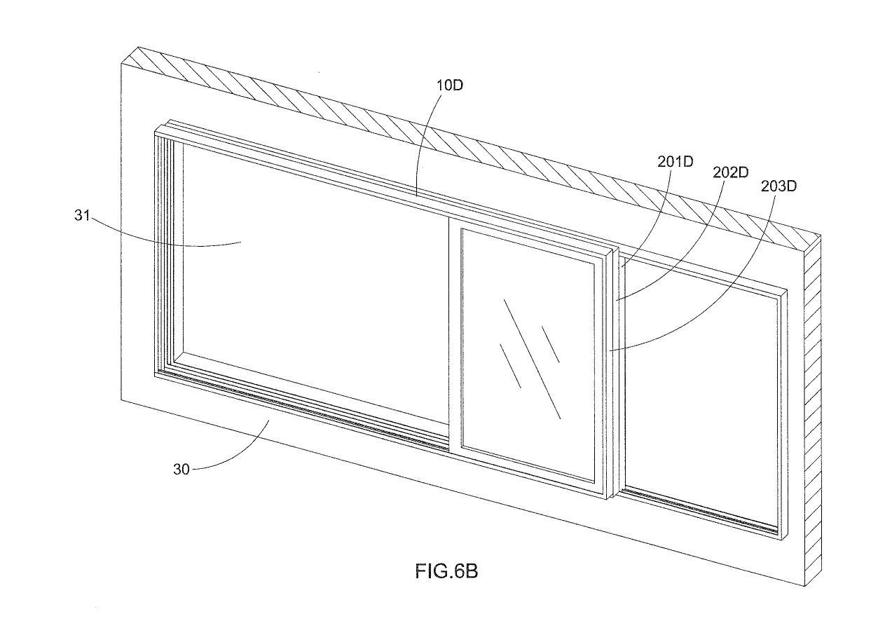

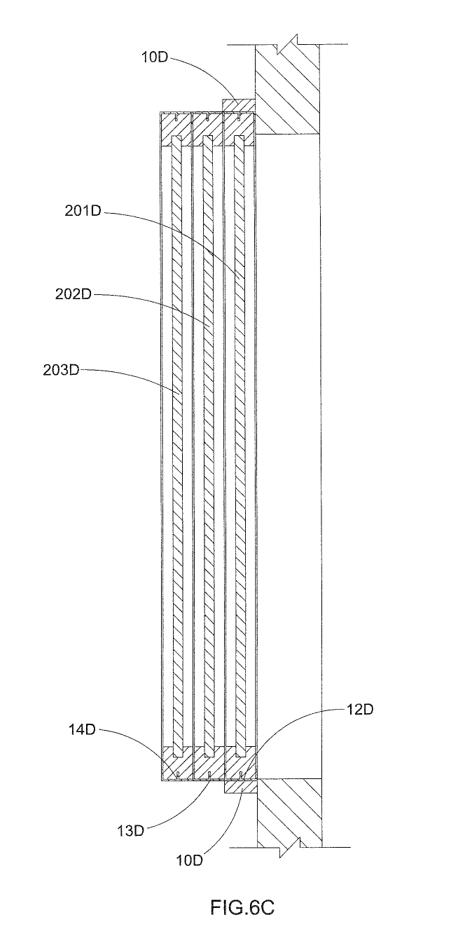

Referring to FIG. 6A to 6C of the drawings, a fully open window arrangement according to a fourth preferred embodiment of the present invention is illustrated. The fully open window arrangement, which is adapted for fully exposing, partially exposing, or fully closing the opening 31 of the wall, comprises a mounting frame 10D, and three window panels 20D.

According to this fourth preferred embodiment, the mounting frame 10D comprises a first guide rail 12D for coupling with a first window panel 201D, a second guide rail 13D mounted at the first window panel 201D for coupling with a second window panel 202D, and a third guide rail 14D mounted at the second window panel 202D for coupling with a third window panel 203D.

Preferably, the second guide rail 13D is mounted at a lower end portion of the first window panel 201D, the third guide rail 14D is mounted at a lower end portion of the second window panel 202D, so that when in the fully open state, the three window panels 201D, 202D and 203D are arranged in a stack manner. Accordingly, when in the closed state, the three window panels 201D, 202D and 203D are guided to slide along corresponding first, second, and third guide rails 12D, 13D, and 14D to a position overlapping with the opening 31 of the wall 30 so as to fully close the opening 31 of the wall 30.

Accordingly, a variety of partial opening states also can be provided for the fully open window arrangement. For example, when the first window panel 201D is moved to overlap with the opening 31 of the wall 30, one third of the open space of the opening 31 is closed, and at the same time, because the second guide rail 13D is mounted at the first window panel 201D, the second and third window panel 202D and 203D also move together with the first window panel 201D to overlap with the first window panel 201. When the second window panel 202D is then guided to move along the second guide rail 13D to close the opening 31 of the wall, the third window panel 203D also moves together with the second window panel 202D for the third guide rail 14D is mounted at the second window panel 202D. In this state, only one third of the open space of the opening 31 of the wall 30 is exposed.

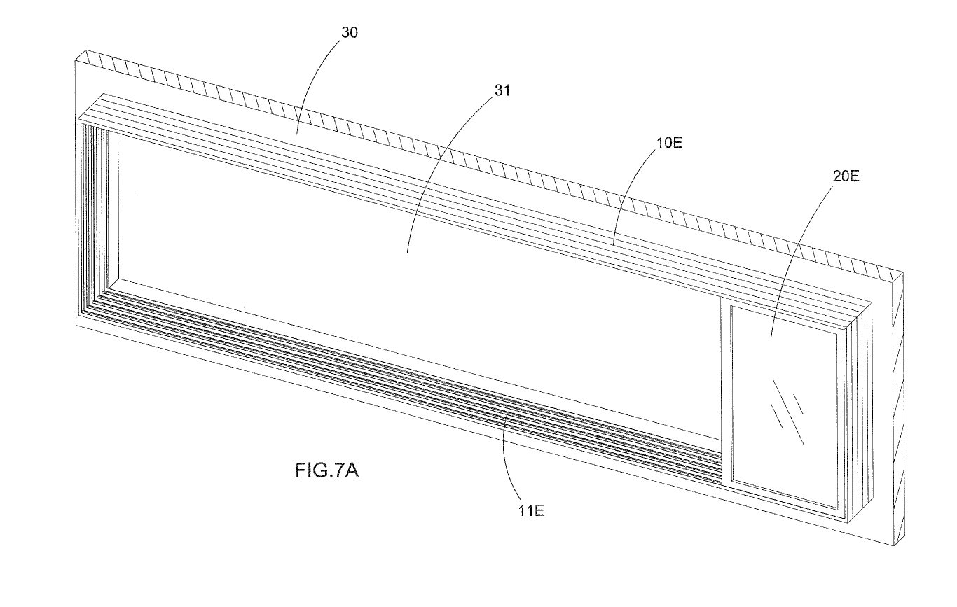

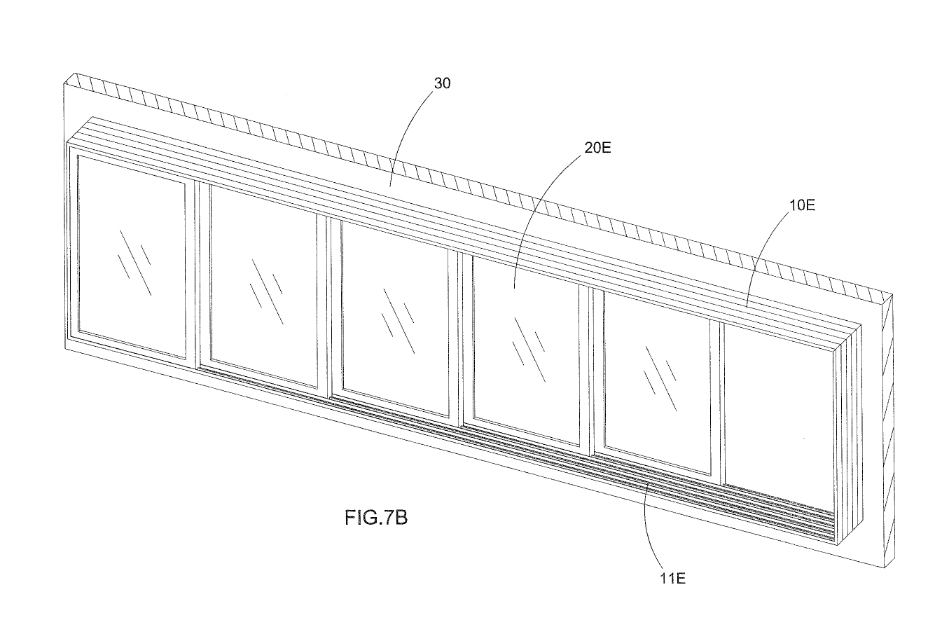

Referring to FIGS. 7A to 7B of the drawings, a fully open window arrangement according to a fifth preferred embodiment of the present invention is illustrated. The fully open window arrangement, which is adapted for fully exposing, partially exposing, or fully closing a larger opening 31 of the wall 30, comprises a mounting frame 10E, and five window panels 20E.

The window arrangement of this preferred embodiment is adapted for coupling with an elongated larger opening 31 of the wall 30. Accordingly, the mounting frame 10E comprises at least five guide rails 11E for coupling with the five window panels 20E respectively. As shown in FIG. 7A of the drawings, when in the fully open state, the five window panels 20E are respectively slid along the five guide rails 11E to a position beside the opening 31 of the wall 30, so that the opening 31 of the wall 30 can be fully exposed. As shown in FIG. 7B of the drawings, when in the fully closed state, the five window panels 20E are respectively slid along the five guide rails 11E to overlap with the opening 31 of the wall 30 so as to fully conceal the opening 31 of the wall 30.

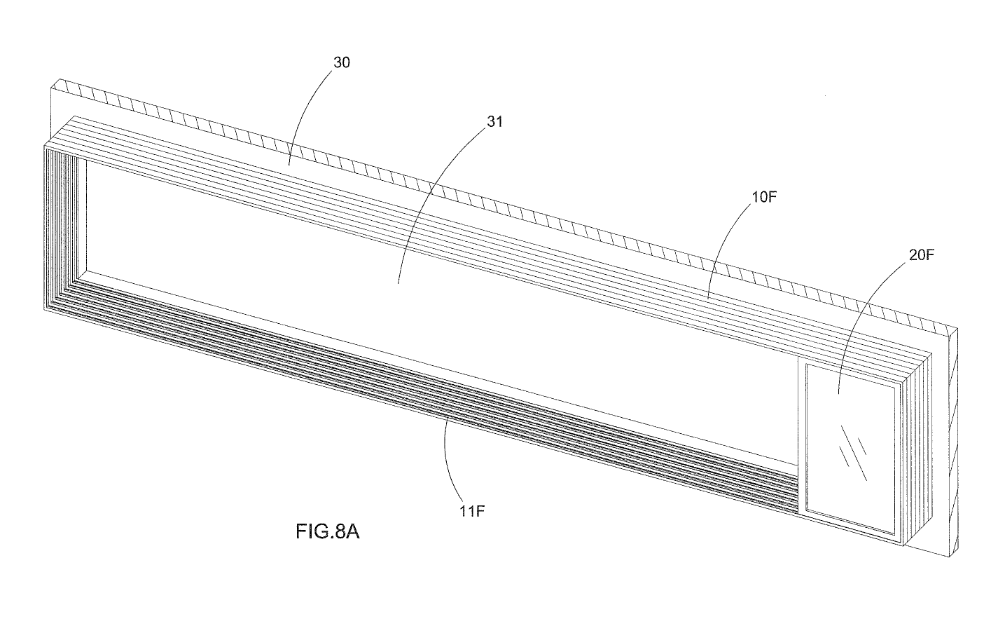

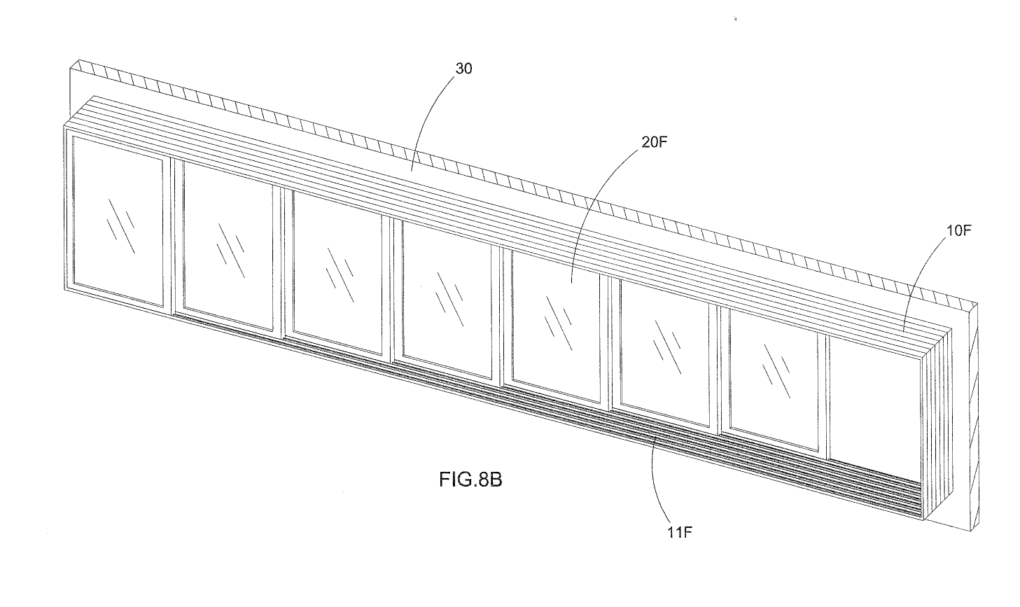

Referring to FIGS. 8A to 8B of the drawings, a fully open window arrangement according to a sixth preferred embodiment of the present invention is illustrated. The fully open window arrangement, which is which is adapted for fully exposing, partially exposing, or fully closing a larger opening 31 of the wall 30, comprises a mounting frame 10F, and seven window panels 20F.

Similarly, the window arrangement of this preferred embodiment is also adapted for coupling with an elongated larger opening 31 of the wall 30. Accordingly, the mounting frame 10F comprises at least seven guide rails 11F for coupling with the seven window panels 20F respectively. As shown in FIG. 8A of the drawings, when in the fully open state, the seven window panels 20F are respectively slid along the seven guide rails 11F to a position beside the opening 31 of the wall 30, so that the opening 31 of the wall 30 can be fully exposed. As shown in FIG. 8B of the drawings, when in the fully closed state, the seven window panels 20F are respectively slid along the seven guide rails 11F to overlap with the opening 31 of the wall 30 so as to fully conceal the opening 31 of the wall 30.

Accordingly, in the above fifth and sixth preferred embodiment of the present invention, the panel arrangement which is embodied as the window arrangement can be provided with multiple guide rails. The multiple guide rails are parallelly aligned with each other for coupling with multiple parallel window panels respectively. In other words, the mounting frame of the present invention is mounted on the wall 30 at an outer side of the opening 31, the area defined within the mounting frame is larger than the opening 31 of the wall 30. For example, the mounting frame is one half, one third, one fourth, one fifth, or one seventh larger than the opening 31 of the wall. The extra area of the mounting frame beside the opening 31 of the wall 30 is used for the accommodation of the window panels. It is worth mentioning that by means of the structure of the window arrangement of the instant invention, multiple window panels with multiple guide rails can be provided for coupling with the elongated larger opening 31 of the wall, so as to adjust the effective open space defined by the window arrangement. If the wall 30 of the window opening 31 does not provide any space adjacent to the window opening 31, the panels 20 of the fully open window arrangement cannot be moved to a position beside the opening 31 for fully exposing the opening 31. In this case, the fully open window arrangement using multiple guide rails 11 with more than two multiple panels 20 can still increase the open space via narrower window panels 20 in comparison with the conventional window arrangement.

As an example, referring to FIGS. 8A and 8B of the drawings, when the mounting frame 10F is mounted with seven window panels 20F, a user can chose to slide one or more of the window panels 20F along one or more guide rails 11F respectively to partially close the opening 31 of the wall 30. In other words, for a larger opening 31 of the wall 30, the user is capable of selectively adjusting the effective open space of the opening 31 of the wall 30.

It is worth mentioning that since the opening 31 of the wall 30 is vacant, it can be used for other purposes. For example, a screen window for keeping out flies and dust can be installed within the opening 31. Alternatively, the opening 31 of the wall may provide an accommodation space for a pot plant.

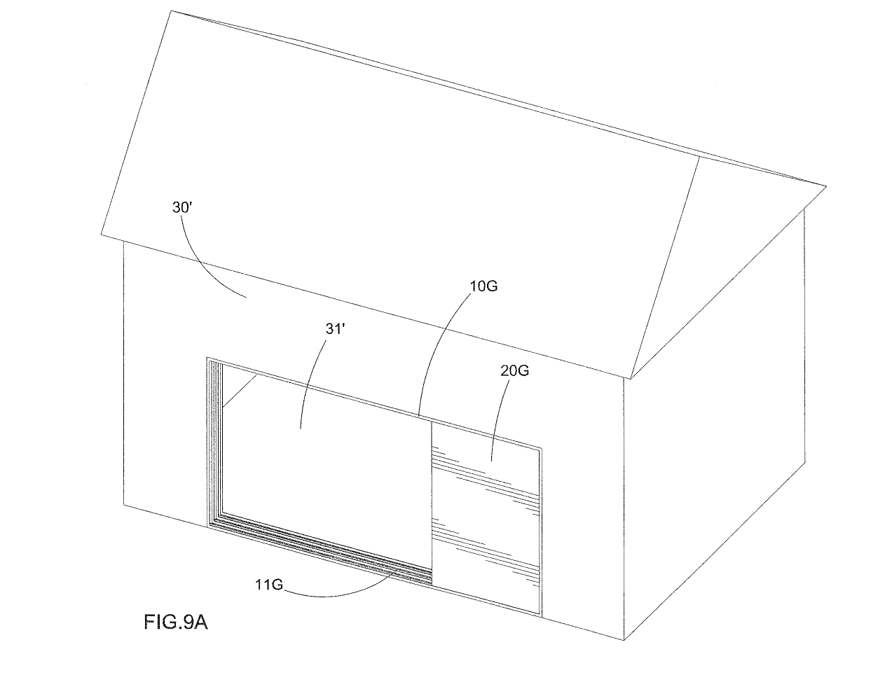

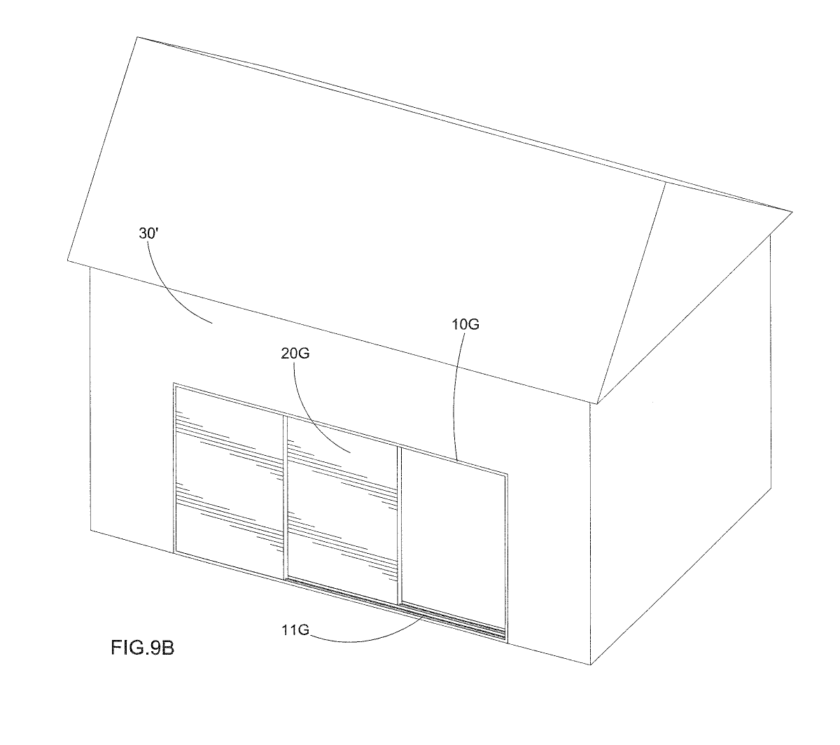

Referring to FIGS. 9A and 9B of the drawings, a fully open panel arrangement according to a seventh preferred embodiment of the present invention is illustrated. The fully open panel arrangement is arranged for coupling with a door opening 31′ of a wall 30′. In other words, the fully open panel arrangement of this preferred embodiment is embodied as a fully open door arrangement and comprises one or more opening panels, and a mounting frame 10G. Accordingly, in this preferred embodiment, the opening panels are embodied as door panels 20G.

According to this seventh preferred embodiment of the present invention, the fully open door arrangement, which comprises two door panels 20G, is capable of moving between a fully open state, a partial open state, and a closed state. In the fully open state, the two door panels 20G move to a position beside the door opening 31′ for fully exposing the opening 31′. In the partial open state, one or two of the two door panels 20G overlap with the door opening 31′ for exposing a partial part of the door opening 31′. In the closed state, the two door panels 20G close the whole door opening 31′.

More specifically, the mounting frame 10G comprises two sets of guide rails 11G for coupling with the two door panels 20G respectively. For example, the two groups of the guide rails 11G are parallelly and spacedly arranged for guiding the sliding movement of the two door panels 20G. Accordingly, a user can selectively guide one or both two of the door panels 20G to slide along the corresponding set of guide rails 11G to overlappedly align with the door opening 31′, so that the fully open window arrangement can be guided to stay in the partial open state. For example, one door panel 20G is guided to a position overlapping with the door opening 31′, so that a half portion of the door opening 31′ can be exposed. Alternatively, the two door panels 20G may stagger with each other for partially exposing the door opening 31′.

Therefore, unlike the prior art in which conventional door panels are mounted within the door opening of the wall, the door panels 20G of the present invention can be moved to a position beside the door opening 31′, and thus the door opening 31′ can be fully exposed when in the fully open state. That is because the mounting frame 10G is not installed within the door opening 31′, but is mounted on the wall 30′ outside of the door opening 31′.

Similarly, the mounting frame 10G of the present invention can be mounted on the wall 30′ around the door opening 31′ and the size of the mounting frame 10G is larger than the door opening 31′, multiple guide rails 11G can be arranged for guiding the movement of the door panels 20G, so that it is convenient for adjusting the effective open space of the door opening 31′.

Accordingly, the present invention actually provides a method of providing a fully open panel arrangement for opening and closing an opening 31 of a wall 30, the method comprises the following steps.

(a) Overlap one or more panels 20 with the opening 31 of the wall to close the opening 31 of the wall 30.

(b) Move each of the panels 20 to a position beside the opening 31 of the wall 30 to fully expose the opening 31 of the wall 30.

Accordingly, in this method, the panels 20 can be embodied as window panels or door panels, so that the panel arrangement can be correspondingly embodied as a window arrangement or a door arrangement.

The fully open window/door arrangement is not installed within the opening 31 of the wall. In other words, the fully opening window/door arrangement is installed at an outer or inner side of the wall 30, but is not within the opening 31. If the wall 31 of a window/door opening 31 does not provide any space adjacent to the window/door opening 31, the panels 20 of the fully open window/door arrangement cannot be moved to a position beside the opening 31 for fully exposing the opening. In this case, the fully open window/door arrangement using multiple guide rails 11 with more than two multiple panels 20 can still increase the open space via narrower window panels 20 in comparison with the conventional window/door arrangement.

The step (a) may further comprise a step of configuring the panels 20 to a position adjacent to the opening 31 at an inner side of the wall 30. Alternatively, the step (a) may further comprise a step of configuring the panels 20 to a position adjacent to the opening 31 at an outer side of the wall 30.

The step (b) may comprise a step of sliding the panels 20 along corresponding guide rails 11 of a mounting frame 10 so as to move away from the opening 31 of the wall.

The method may further comprise a step (c) of partially exposing the opening 31 of the wall 30 by moving the panels 20 to partially overlap with the opening 31 of the wall 30.

The guide rails 11 may be provided at the mounting frame 10. Alternatively, a guide rail 11 of adjacent panel 20 may be installed at the adjacent panel 20. In addition, the panels 20 may move in a horizontal direction or a vertical direction to open or close the opening 31 of the wall 30.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A fully open panel arrangement for opening and closing an opening of a wall, comprising:
one or more opening panels; and
a mounting frame mounting said opening panels in position, wherein said mounting frame is mounted to said wall outside of said opening, wherein in a fully open state, each of said opening panels moves to a position beside said opening for fully exposing said opening.

2. The fully open panel arrangement, as recited in claim 1, wherein said mounting frame is mounted adjacent to said opening at an inner side of said wall.

3. The fully open panel arrangement, as recited in claim 1, wherein said mounting frame is mounted adjacent to said opening at an outer side of said wall.

4. The fully open panel arrangement, as recited in claim 2, wherein said mounting frame comprises one or more guide rails which couple with said opening panels respectively for enabling sliding movement of said opening panels.

5. The fully open panel arrangement, as recited in claim 3, wherein said mounting frame comprises one or more guide rails which couple with said opening panels respectively for enabling sliding movement of said opening panels.

6. The fully open panel arrangement, as recited in claim 4, wherein said two or more opening panels are arranged in a same plane.

7. The fully open panel arrangement, as recited in claim 5, wherein said two or more opening panels are arranged in a same plane.

8. The fully open panel arrangement, as recited in claim 4, wherein said two or more guide rails are spacedly and parallelly arranged to couple with two or more opening panels respectively.

9. The fully open panel arrangement, as recited in claim 5, wherein said two or more guide rails are spacedly and parallelly arranged to couple with two or more opening panels respectively.

10. The fully open panel arrangement, as recited in claim 9, wherein when in the fully open state, said two or more opening panels move to a same side of said opening and overlap with each other in a stack manner.

11. The fully open panel arrangement, as recited in claim 9, wherein when in the fully open state, said two or more opening panels move to different sides of said opening respectively in such a manner that said opening is exposed between said two or more window panels.

12. The fully open panel arrangement, as recited in claim 2, wherein one or more guide rails are provided at said one or more opening panels respectively for coupling with an adjacent opening panels of said one or more opening panels.

13. The fully open panel arrangement, as recited in claim 3, wherein one or more guide rails are provided at said one or more opening panels respectively for coupling with an adjacent opening panels of said one or more opening panels.

14. The fully open panel arrangement, as recited in claim 2, wherein said mounting frame comprises a first guide rail for coupling with a first opening panel of said opening panels, a second guide rail mounted at said first opening panel for coupling with a second opening panel of said opening panels, and a third guide rail mounted at said second opening panel for coupling with a third opening panel of said opening panels.

15. The fully open panel arrangement, as recited in claim 3, wherein said mounting frame comprises a first guide rail for coupling with a first opening panel of said opening panels, a second guide rail mounted at said first opening panel for coupling with a second opening panel of said opening panels, and a third guide rail mounted at said second opening panel for coupling with a third opening panel of said opening panels

16. The fully open panel arrangement, as recited in claim 3, wherein said opening panels move in a horizontal direction to open or close said opening of said wall.

17. The fully open panel arrangement, as recited in claim 3, wherein said opening panels move in a vertical direction to open or close said opening of said wall.

18. The fully open panel arrangement, as recited in claim 3, wherein a total area of said opening panels is larger than an area of said opening.

19. The fully open panel arrangement, as recited in claim 1, wherein each of said opening panel is a window panel, wherein said fully opening panel arrangement is a window arrangement.

20. The fully open panel arrangement, as recited in claim 11, wherein each of said opening panel is a window panel, wherein said fully opening panel arrangement is a window arrangement.

21. The fully open panel arrangement, as recited in claim 1, wherein each of said opening panel is a door panel, wherein said fully opening panel arrangement is a door arrangement and said opening is a door opening.

22. The fully open panel arrangement, as recited in claim 14, wherein each of said opening panel is a door panel, wherein said fully opening panel arrangement is a door arrangement and said opening is a door opening.

23. The fully open panel arrangement, as recited in claim 4, wherein said mounting frame comprises three or more guide rails each for guiding the sliding movement of said opening panels.

24. The fully open panel arrangement, as recited in claim 4, wherein said mounting frame comprises at least five guide rails for coupling with five opening panels respectively.

25. The fully open panel arrangement, as recited in claim 4, wherein said mounting frame comprises at least seven guide rails for coupling with seven opening panels respectively.

26. A method of operating a fully open panel arrangement for opening and closing an opening of a wall, comprising the following steps:
(a) overlapping one or more opening panels with said opening of said wall to close said opening of said wall; and
(b) moving each of said opening panels to a position beside said opening of said wall to fully expose said opening of said wall.

27. The method, as recited in claim 26, wherein said fully open panel arrangement is installed at said wall outside of said opening.

28. The method, as recited in claim 26, wherein the step (a) further comprises a step of configuring said opening panels to a position adjacent to said opening at an inner side of said wall.

29. The method, as recited in claim 26, wherein the step (a) further comprises a step of configuring said opening panels to a position adjacent to said opening at an outer side of said wall.

30. The method, as recited in claim 26, wherein the step (b) further comprises a step of sliding said opening panels along corresponding guide rails of a mounting frame so as to move away from said opening of said wall.

31. The method, as recited in claim 26, wherein the step (b) further comprises a step of sliding one of said opening panels along a corresponding guide rail which is installed at an adjacent opening panel of said opening panels so as to move away from said opening of said wall.

32. The method, as recited in claim 26, further comprising a step (c) of partially exposing said opening of said wall by moving said opening panels to partially overlap with said opening of said wall.

33. The method, as recited in claim 26, wherein said opening panels move in a horizontal direction to open and close said opening of said wall.

34. The method, as recited in claim 26, wherein said opening panels move in a vertical direction to open and close said opening of said wall.

35. The method, as recited in claim 26, wherein each of said opening panels is a window panel, wherein said opening is a window opening.

36. The method, as recited in claim 26, wherein each of said opening panels is a door panel, wherein said opening is a door opening.
